(19) United States
(12) Patent Application Publication
(10) Pub. No.: US 2012/0188475 A1
(43) Pub. Date: Jul. 26, 2012

(54) DISPLAY DEVICE, BARRIER DEVICE, AND METHOD OF DRIVING DISPLAY DEVICE

(75) Inventor: Yuichi Inoue, Kanagawa (JP)

(73) Assignee: Sony Corporation, Tokyo (JP)

(21) Appl. No.: 13/351,373

(22) Filed: Jan. 17, 2012

(30) Foreign Application Priority Data
Jan. 24, 2011 (JP) 2011-012179

(51) Int. Cl. G02F 1/133

(52) U.S. Cl. 349/36

(57) ABSTRACT

A display device includes a liquid crystal barrier section including a plurality of liquid crystal barriers; a barrier drive section supplying a plurality of barrier drive signals to the plurality of liquid crystal barriers, thereby to allow each of the liquid crystal barriers to be opened and closed; and a display section displaying images. Each of the barrier drive signals includes a first waveform portion with a first wave height value, a second waveform portion, and a third waveform portion maintained at a basal potential, the second waveform portion being arranged immediately before the first waveform portion and having a second wave height value smaller than the first wave height value.

### BACKGROUND

This disclosure relates to a display device capable of achieving stereoscopic display by a parallax barrier system, a barrier device, and a method of driving a display device.

Recently, attention has been focused on a display device capable of achieving stereoscopic display. In stereoscopic display, a left-eye image and a right-eye image with parallax therebetween (with different eyepoints) are displayed, and when a viewer views the respective images with two eyes, the viewer may perceive the images as a deep stereoscopic image. In addition, a display device has been developed, which displays three or more images with parallax therebetween, making it possible to provide a more natural stereoscopic image to a viewer.

Such a display device is roughly classified into two types: one using special glasses and the other using no special glasses. Since the special glasses are often unpleasant for a viewer, the type using no special glasses has been generally desired. A display device requiring no special glasses includes, for example, a lenticular lens type and a parallax barrier type. In such types, a plurality of images (perspective images) with parallax therebetween is displayed at a time, and a viewer views different images depending on a relative positional relationship (angle) between the display device and an eyepoint of the viewer.

In the case where such a display device displays a plurality of perspective images, there is an issue that a substantial resolution of images are determined by dividing a resolution of the display device itself such as a CRT (Cathode Ray Tube) and a liquid crystal display device by a number of eyepoints, and thus an image quality is deteriorated. Various studies are being conducted in order to solve the issue. For example, in Japanese Unexamined Patent Application Publication No. 2007-114793, a parallax barrier type display device is proposed, which displays images by time-divisionally switching a transmissive state (open state) and a blocking state (closed state) of each of a plurality of liquid crystal barriers arranged in a display plane to improve a resolution equivalently.

In the display device, high response speed is generally desired. For example, when a moving image is displayed, low response speed of the display device causes an afterimage of each displayed image, and the display quality may be deteriorated. To solve the issue, for example, a display device in which response speed of the liquid crystal is increased by a technique of applying a voltage higher than a desired voltage transiently to a liquid crystal element in a liquid crystal display device, so-called overdrive technique, is proposed (for example, Japanese Unexamined Patent Application Publication Nos. 2004-220022 and 2010-49014). The overdrive technique improves the response speed of the liquid crystal in the case where displays are switched in a halftone (gray scale).

### SUMMARY

In a parallax barrier type display device using liquid crystal barriers, the liquid crystal barriers are desirably opened and closed rapidly. If the liquid crystal barriers are not opened and closed rapidly, for example, display luminance is lowered or so-called crosstalk in which a mixed image of a left-eye image and a right-eye image is observed possibly occurs. However, in Japanese Unexamined Patent Application Publication No. 2007-114793, a method of allowing liquid crystal barriers to perform open operation and close operation rapidly is not described at all. In addition, unlike a liquid crystal display device mainly displaying a halftone image (gray scale image), the liquid crystal barriers are switched and operated between an open state (transmissive state) and a closed state (blocking state), and therefore even if the overdrive technique of the liquid crystal display device disclosed in Japanese Unexamined Patent Application Publication Nos. 2004-220022 and 2010-49014 is applied to the liquid crystal barriers, the response speed of the liquid crystal may not be increased.

It is desirable to provide a display device, a barrier device, and a method of driving a display device which are capable of increasing the response speed of a liquid crystal barrier.

A display device according to an embodiment of the disclosure includes a liquid crystal barrier section, a barrier drive section, and a display section. The liquid crystal barrier section includes a plurality of liquid crystal barriers. The barrier drive section supplies a plurality of barrier drive signals to the plurality of liquid crystal barriers, thereby to allow each of the liquid crystal barriers to be opened and closed. The display section displays images. Each of the above-described plurality of barrier drive signals includes a first waveform portion with a first wave height value, a second waveform portion, and a third waveform portion maintained at a basal potential. The second waveform portion is arranged immediately before the first waveform portion, and has a second wave height value smaller than the first wave height value.

A barrier device according to an embodiment of the disclosure includes a liquid crystal barrier section and a barrier drive section. The liquid crystal barrier section includes a plurality of liquid crystal barriers. The barrier drive section supplies a plurality of barrier drive signals to the plurality of liquid crystal barriers, thereby to allow each of the liquid crystal barriers to be opened and closed. Each of the plurality of barrier drive signals includes a first waveform portion with a first wave height value, a second waveform portion, and a third waveform portion maintained at a basal potential. The second waveform portion is arranged immediately before the first waveform portion, and has a second wave height value smaller than the first wave height value.

A method of driving a display device according to an embodiment of the disclosure includes supplying a plurality of barrier drive signals which are different from one another to a plurality of liquid crystal barriers, thereby allowing each of the liquid crystal barriers to be opened and closed, and displaying images on a display section. The plurality of barrier drive signals each include a first waveform portion with a first wave height value, a second waveform portion, and a third waveform portion maintained at a basal potential. The second waveform portion is arranged immediately before the first waveform portion, and has a second wave height value smaller than the first wave height value.

In the display device, the barrier device, and the method of driving a display device according to the embodiments of the disclosure, an image displayed on the display section is perceived as a stereoscopic image by open operation and close operation of the plurality of liquid crystal barriers. At this time, the liquid crystal barriers are driven by the barrier drive signals each including the second waveform portion, the first waveform portion, and the third waveform portion. Accordingly, after the liquid crystal barriers become a blocking state by application of the third waveform portion, the liquid crystal barriers become a preparation state for an open state by application of the second waveform portion, and then become an open state by application of the first waveform portion.

In the display device according to the embodiment of the disclosure, for example, the plurality of liquid crystal barriers is desirably grouped into a plurality of barrier groups. The barrier drive section desirably supplies the plurality of barrier drive signals which are different from each other to the plurality of barrier groups, respectively, thereby to allow the plurality of liquid crystal barriers to perform open operation and close operation at timings which are different from one another between the barrier groups. The display section desirably displays images in synchronization with open operation and close operation of the liquid crystal barriers included in each of the barrier groups. In addition, for example, the barrier drive section sets open operation periods to be arranged cyclically among the barrier groups, and during each of the open operation periods, performs tasks of supplying the first waveform portion to the liquid crystal barriers included in a barrier group which is intended to perform open operation, supplying the second waveform portion to the liquid crystal barriers included in a barrier group which currently stays in the closed state and is intended to perform open operation during a subsequent open operation period, and supplying the third waveform portion to the liquid crystal barriers included in a barrier group which currently stays in the closed state and is intended to perform close operation during the subsequent open operation period.

Moreover, for example, a temperature sensor and a wave height data storing section which stores a plurality of pieces of wave height data for instructing the second wave height value may be further provided, and the barrier drive section may select one of the plurality of pieces of wave height data based on a detection result of the temperature sensor, and generate the barrier drive signals based on the selected wave height data.

Furthermore, for example, the barrier drive signal may be a cyclic signal configured of a repeated arrangement of a first waveform unit including the second waveform portion, the first waveform portion, and the third waveform portion, or may include first and second waveform units which are alternately arranged, the second waveform unit being an inversion of the first waveform unit. In addition, for example, in the barrier drive signal, a time period of a positive voltage and a time period of a negative voltage are desirably equal, in length, to each other.

Moreover, for example, the second waveform portion may have a DC waveform, or have a waveform with alternately-inverted polarity. In addition, for example, the second wave height value is desirably a voltage level which allows the liquid crystal barriers to stay in a closed state through applying the second waveform portion thereto.

Furthermore, for example, the plurality of liquid crystal barriers each desirably extend in a predetermined direction, and are desirably arranged side by side to allow the barrier groups to be cyclically repeated in a direction intersecting the predetermined direction.

Moreover, for example, the display device according to the embodiment of the disclosure may include a plurality of display modes including a three-dimensional image display mode and a two-dimensional image display mode. The liquid crystal barrier section may further include a plurality of liquid crystal sub-barriers. The three-dimensional image display mode allows three-dimensional image to be displayed, through displaying a plurality of different perspective images by the display section, allowing the plurality of liquid crystal barriers to stay in the opened state, and allowing the plurality of liquid crystal sub-barriers to stay in the closed state. The two-dimensional display mode allows two-dimensional image to be displayed, through displaying one perspective image, and allowing both the plurality of liquid crystal barriers and the plurality of liquid crystal sub-barriers to stay in the opened state.

Furthermore, for example, the display section may further include a backlight. The display section may be configured of a liquid crystal display section disposed between the backlight and the liquid crystal barrier section. Alternatively, for example, the display section may further include a backlight. The display section may be configured of a liquid crystal display section disposed between the backlight and the liquid crystal display section.

Moreover, for example, in the method of driving a display device according to the embodiment of the disclosure, the plurality of liquid crystal barriers is grouped into a plurality of barrier groups. The plurality of barrier drive signals which are different from each other is supplied to the plurality of barrier groups, respectively, to allow the plurality of liquid crystal barriers to perform open operation and close operation at timings which are different from one another between the barrier groups.

The display device, the barrier device, and the method of driving a display device according to the embodiments of the disclosure, since the second waveform portion having the second wave height value smaller than the first wave height value is applied to the liquid crystal barriers before application of the first waveform portion with the first wave height value, the response speed of the liquid crystal barriers is allowed to be increased.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a configuration example of a stereoscopic display device according to a first embodiment of the disclosure.

FIGS. 2A and 2B are explanatory diagrams illustrating a configuration example of the stereoscopic display device illustrated in FIG. 1.

FIG. 3 is a block diagram illustrating a configuration example of a display drive section and a display section which are illustrated in FIG. 1.

FIG. 4 is a circuit diagram illustrating a configuration example of a pixel illustrated in FIG. 3.

FIGS. 5A and 5B are explanatory diagrams illustrating a configuration example of a liquid crystal barrier section illustrated in FIG. 1.

FIG. 6 is an explanatory diagram illustrating a configuration example of groups of the liquid crystal barrier section illustrated in FIG. 1.

FIG. 7 is a timing waveform chart illustrating a waveform example of a barrier drive signal illustrated in FIG. 1.

FIGS. 8A to 8C are schematic diagrams illustrating an operation example of the display section and the liquid crystal barrier section which are illustrated in FIG. 1.

FIGS. 9A and 9B are schematic diagrams illustrating another operation example of the display section and the liquid crystal barrier section which are illustrated in FIG. 1.

FIG. 10 is a timing chart illustrating an operation example of the stereoscopic display device illustrated in FIG. 1.

FIG. 11 is a timing chart illustrating an operation example of the liquid crystal barrier section illustrated in FIG. 1.

FIGS. 12A to 12E are timing waveform charts each illustrating a waveform example of a barrier drive signal according to a modification of the first embodiment.

FIG. 13 is a timing waveform chart illustrating waveform examples of a barrier drive signal according to another modification of the first embodiment.

FIG. 14 is a timing chart illustrating an operation example of a stereoscopic display device according to still another modification of the first embodiment.

FIG. 15 is a timing waveform chart illustrating waveform examples of a barrier drive signal according to still another modification of the first embodiment.

FIG. 16 is a block diagram illustrating a configuration example of a stereoscopic display device according to a second embodiment of the disclosure.

FIG. 17 is a timing waveform chart illustrating waveform examples of a barrier drive signal illustrated in FIG. 16.

FIGS. 18A and 18B are explanatory diagrams illustrating a configuration example of a stereoscopic display device according to a modification.

FIGS. 19A and 19B are schematic diagrams illustrating operation examples of the stereoscopic display device according to the modification.

FIGS. 20A and 20B are plan views illustrating configuration examples of a liquid crystal barrier according to another modification.

FIGS. 21A to 21C are schematic diagrams illustrating operation examples of a display section and the liquid crystal barrier section according to still another modification.

FIG. 22 is a timing chart illustrating an operation example of a stereoscopic display device according to the still another modification.

### DETAILED DESCRIPTION

Hereinafter, preferred embodiments of the disclosure will be described in detail with reference to drawings. Note that description will be given in the following order.

1. First embodiment
2. Second embodiment

### 1. First embodiment

### Configuration Example

### General Configuration Example

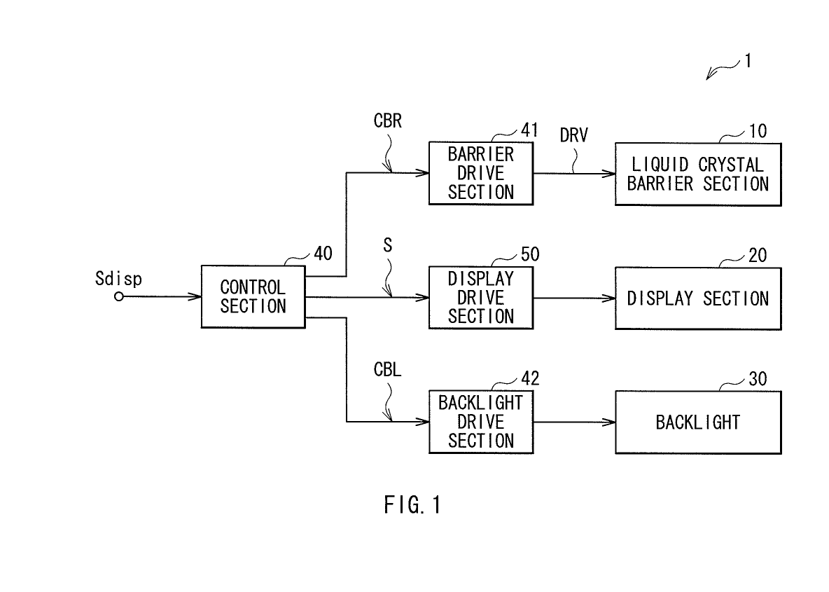

FIG. 1 illustrates a configuration example of a stereoscopic display device according to a first embodiment of the disclosure. Note that since a barrier device and a method of driving a display device according to embodiments of the disclosure are embodied by the embodiment, the barrier device and the method are described together with the display device. A stereoscopic display device 1 includes a control section 40, a display drive section 50, a display section 20, a backlight drive section 42, a backlight 30, a barrier drive section 41, and a liquid crystal barrier section 10.

The control section 40 is a circuit which supplies each of the display drive section 50, the backlight drive section 42, and the barrier drive section 41 with a control signal based on an image signal Sdisp supplied from the outside, and controls these sections to operate in synchronization with one another. Specifically, the control section 40 supplies the display drive section 50 with an image signal S based on the image signal Sdisp, supplies the backlight drive section 42 with a backlight control signal CBL, and supplies the barrier drive section 41 with a barrier control signal CBR. Herein, in the case where the stereoscopic display device 1 performs stereoscopic display, the image signal S is configured of image signals SA and SB each including a plurality of (six in this case) perspective images as will be described later.

The display drive section 50 drives the display section 20 based on the image signal S supplied from the control section 40. The display section 20 is a liquid crystal display section in this case, and performs display by driving liquid crystal display elements and modulating light emitted from the backlight 30.

The backlight drive section 42 drives the backlight 30 based on the backlight control signal CBL supplied from the control section 40. The backlight 30 has a function to emit surface-emitted light with respect to the display section 20. The backlight 30 is configured of, for example, an LED (Light Emitting Diode) or a CCFL (Cold Cathode Fluorescent Lamp).

The barrier drive section 41 generates a cyclic barrier drive signal DRV based on the barrier control signal CBR supplied from the control section 40, and supplies the cyclic barrier drive signal DRV to the liquid crystal barrier section 10. The liquid crystal barrier section 10 allows light which has been emitted from the backlight 30 and then transmitted the display section 20 to pass therethrough (open operation) or to be blocked (close operation), and the liquid crystal barrier section 10 includes a plurality of open/close sections 11 and 12 (described later) each configured with use of a liquid crystal. In this case, as will be described later, the barrier drive signal DRV includes a barrier drive signal DRVA for driving open/close sections 12A (described later) and a barrier drive signal DRVB for driving open/close sections 12B (described later).

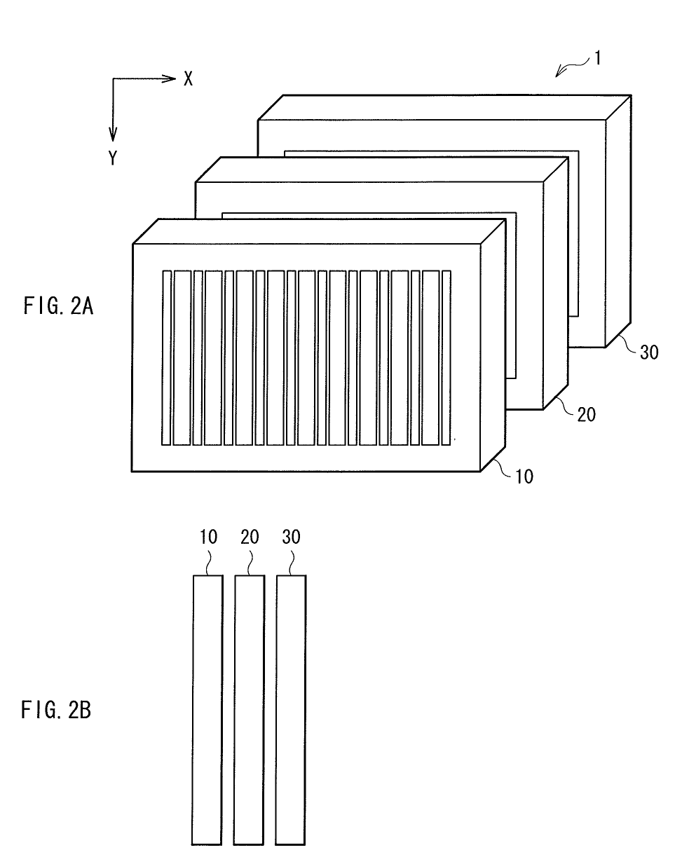

FIGS. 2A and 2B illustrate a configuration example of a relevant part of the stereoscopic display device 1, where FIGS. 2A and 2B illustrates an exploded perspective configuration and a side view of the stereoscopic display device 1, respectively. As illustrated in FIGS. 2A and 2B, respective components of the stereoscopic display device 1 are arranged in order of the backlight 30, the display section 20, and the liquid crystal barrier section 10. In other words, light emitted from the backlight 30 reaches a viewer through the display section 20 and the liquid crystal barrier section 10.

### (Display Drive Section 50 and Display Section 20)

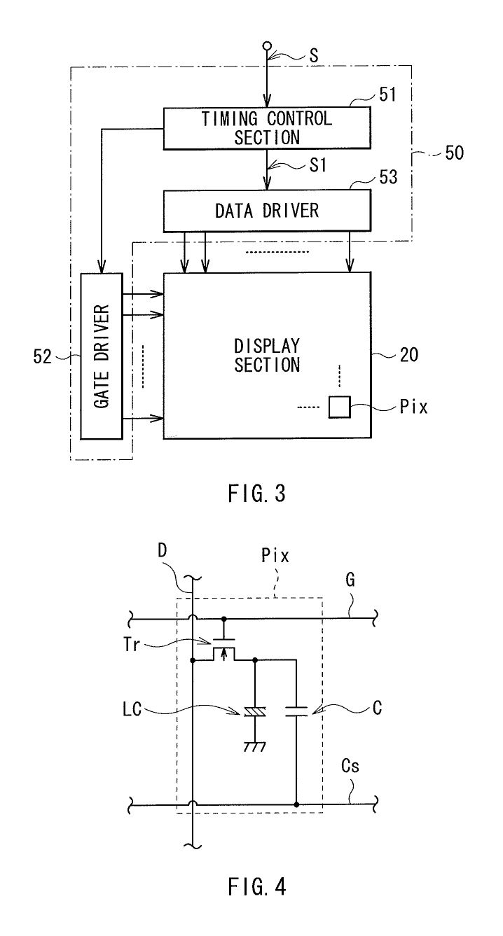

FIG. 3 illustrates an example of a block diagram of the display drive section 50 and the display section 20. The display drive section 50 includes a timing control section 51, a gate driver 52, and a data driver 53. The timing control section 51 controls driving timings of the gate driver 52 and the data driver 53, and supplies the data driver 53 with the image signal S supplied from the control section 40 as the image signal S1. The gate driver 52 sequentially selects pixels Pix in the display section 20 row by row to perform line-sequential scanning according to timing control by the timing control section 51. The data driver 53 supplies each pixel Pix in the display section 20 with a pixel signal based on the image signal S1. Specifically, the data driver 53 performs D/A (digital/analog) conversion based on the image signal S1 to generate a pixel signal as an analog signal, and then supplies the pixel signal to each pixel Pix.

The display section 20 is formed by sealing a liquid crystal material between two transparent substrates each made of, for example, glass. Transparent electrodes each configured of, for example, ITO (Indium Tin Oxide) are formed on portions facing the liquid crystal material of the transparent substrates, and configure pixels Pix with the liquid crystal material. As illustrated in FIG. 3, the pixels Pix are arranged in a matrix in the display section 20.

FIG. 4 illustrates an example of a circuit diagram of the pixel Pix. The pixel Pix includes a TFT (Thin Film Transistor) element Tr, a liquid crystal element LC, and a retention capacitor C. The TFT element Tr is configured of, for example, a MOS-FET (Metal Oxide Semiconductor-Field Effect Transistor), and has a gate connected to a gate line G, a source connected to a data line D, and a drain connected to one end of the liquid crystal element LC and one end of the retention capacitor C. One end of the liquid crystal element LC is connected to the drain of the TFT element Tr, and the other end is grounded. One end of the retention capacitor C is connected to the drain of the TFT element Tr, and the other end is connected to a retention capacitor line Cs. The gate line G is connected to the gate driver 52, and the data line D is connected to the data driver 53.

With such a configuration, light having emitted from the backlight 30 is converted into linear polarized light in a direction determined by a polarizing plate (not illustrated) which is arranged on an incident side of the display section 20, and then the linear polarized light enters the liquid crystal element LC. In the liquid crystal element LC, a direction of a liquid crystal molecule is changed at a certain response time according to the pixel signal supplied through the data line D. The polarization direction of light having entered such a liquid crystal element LC is changed. Then, light having passed through the liquid crystal element LC enters a polarizing plate (not illustrated) arranged on a light emission side of the display section 20, and the polarizing plate allows only light in a specific polarization direction to pass therethrough. In this way, intensity modulation of light is performed in the liquid crystal element LC.

### (Liquid Crystal Barrier Section 10 and Barrier Drive Section 41)

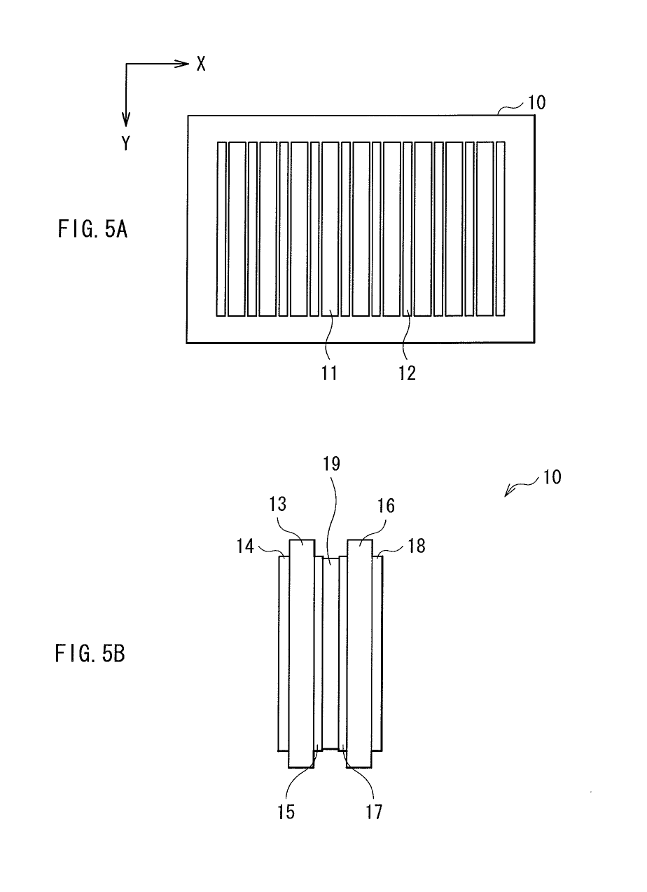

FIGS. 5A and 5B illustrate a configuration example of the liquid crystal barrier section 10, where FIGS. 5A and 5B illustrate a plan view and a side view of the liquid crystal barrier section 10, respectively.

As illustrated in FIG. 5A, the liquid crystal barrier section 10 includes a plurality of open/close sections (liquid crystal barriers) 11 and 12 which allow light to pass therethrough or to be blocked. The open/close sections 11 and the open/close sections 12 are alternately arranged side by side in an x-axis direction, and are formed to extend in a y-axis direction (sequential scanning direction). The open/close sections 11 and 12 perform different operations depending on whether the stereoscopic display device 1 performs a normal display (two-dimensional display) or a stereoscopic display. Specifically, as will be described later, the open/close sections 11 become an open state (transmissive state) when the stereoscopic display device 1 performs the normal display, and become a closed state (blocking state) when the stereoscopic display device 1 performs the stereoscopic display. The open/close sections 12, as will be described later, become an open state (transmissive state) when the stereoscopic display device 1 performs the normal display, and time-divisionally performs open/close operations when the stereoscopic display device 1 performs the stereoscopic display.

As illustrated in FIG. 5B, the liquid crystal barrier section 10 includes a transparent substrate 13, a transparent substrate 16 disposed to face the transparent substrate 13, and a liquid crystal layer 19 inserted between the transparent substrates 13 and 16. The transparent substrates 13 and 16 are formed of, for example, glass. A transparent electrode 15 made of, for example, ITO is formed on a surface on the liquid crystal layer 19 side of the transparent substrate 13, and a plurality of transparent electrodes 17 made of, for example, ITO is formed on a surface on the liquid crystal layer 19 side of the transparent substrate 16. In this example, a voltage of 0 V is applied to the transparent electrode 15, and the barrier drive section 41 applies the barrier drive signal DRV to the transparent electrodes 17. As will be described later, the barrier drive section 41 applies the barrier drive signal DRV independently to each of the open/close sections 11 and the open/close sections 12 (12A and 12B) so as to allow these open/close sections to perform open/close operations, independently. The transparent electrode 15 provided on the transparent substrate 13 and the transparent electrodes 17 provided on the transparent substrate 16 are arranged on positions corresponding to each other, and the transparent electrodes 15 and 17 form the open/close sections 11 and 12 with the liquid crystal layer 19. The liquid crystal layer 19 modulates light passing therethrough according to a state of an electric field, and is configured with use of a VA (vertical alignment) mode liquid crystal, for example. A polarizing plate 14 is formed on an opposite surface of the transparent substrate 13 from the liquid crystal layer 19, and a polarizing plate 18 is formed on an opposite surface of the transparent substrate 16 from the liquid crystal layer 19. Incidentally, although not illustrated in FIG. 5B, the display section 20 and the backlight 30 are arranged in order illustrated in FIG. 2B on a right side of the liquid crystal barrier section 10 (on a right side of the polarizing plate 18).

The open/close operations of the open/close sections 11 and 12 of the liquid crystal barrier section 10 are similar to the display operation of the display section 20. The light having been emitted from the backlight 30 and then passed through the display section 20 is converted into linear polarized light in a direction determined by the polarizing plate 18, and then enters the liquid crystal layer 19. In the liquid crystal layer 19, the direction of the liquid crystal molecule is changed at a certain response time according to a potential difference between the transparent electrodes 15 and 17. The polarization direction of the light having entered such a liquid crystal layer 19 is changed. After that, the light having passed through the liquid crystal layer 19 enters the polarizing plate 14, and the polarizing plate 14 allows only light in a specific polarization direction to pass therethrough. In this way, intensity modulation of light is performed in the liquid crystal layer 19.

With this configuration, as a voltage is applied to the transparent electrodes 15 and 17 and the potential difference therebetween is increased, light transmittance in the liquid crystal layer 19 is increased and the open/close sections 11 and 12 become a transmissive state. On the other hand, as the potential difference between the transparent electrodes 15 and 17 is decreased, light transmittance in the liquid crystal layer 19 is decreased and the open/close sections 11 and 12 become a blocking state.

In the liquid crystal barrier section 10, the plurality of open/close sections 12 configures groups. When the stereoscopic display is performed, the plurality of open/close sections 12 included in one group performs the open operation and the close operation at the same timing. The groups of the open/close sections 12 will be described below.

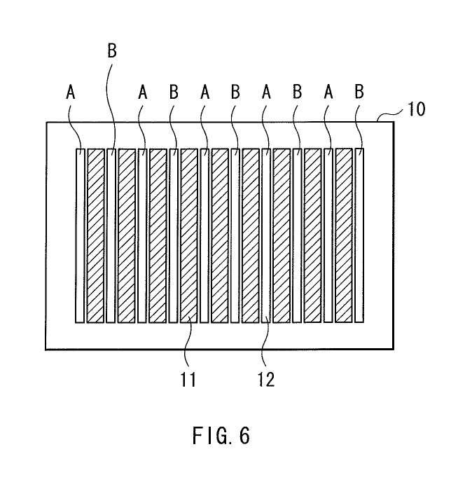

FIG. 6 illustrates a configuration example of the groups of the open/close sections 12. The open/close sections 12 configure two groups in this example. Specifically, the plurality of open/close sections 12 is alternately included in a group A and a group B. Incidentally, hereinafter, the open/close section 12A is appropriately used as a general term of the open/close section 12 included in the group A, and similarly, the open/close section 12B is appropriately used as a general term of the open/close section 12 included in the group B.

When the stereoscopic display is performed, the barrier drive section 41 drives the plurality of open/close sections 12 included in one group to allow the open/close sections 12 to perform open operation and close operation at the same timing, and drives groups to allow the groups to perform open operation and close operation at timings which are different from one another between groups. Specifically, as will be described later, the barrier drive section 41 supplies the barrier drive signal DRVA to the plurality of open/close sections 12A included in the group A, and supplies the barrier drive signal DRVB to the plurality of open/close sections 12B included in the group B. In this example, the barrier drive signals DRVA and DRVB have the same waveform and phases shifted from each other. The plurality of open/close sections 12A and the plurality of open/close sections 12B time-divisionally and alternately perform the open operation and the close operation.

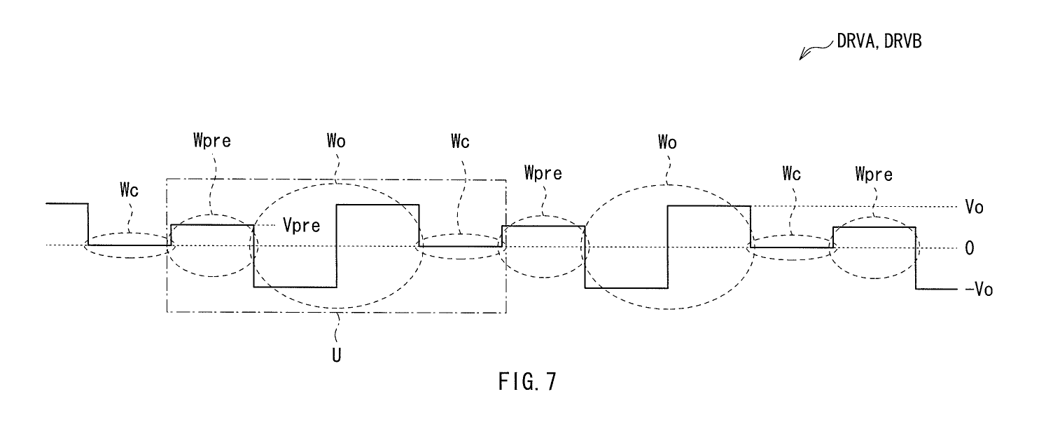

FIG. 7 illustrates a waveform example of the barrier drive signals DRVA and DRVB generated by the barrier drive section 41. The barrier drive section 41 drives the liquid crystal barrier section 10 by AC driving. Each of the barrier drive signals DRVA and DRVB is a cyclic signal having a close drive waveform portion Wc, an open drive waveform portion Wo, and a preparation drive waveform portion Wpre.

The close drive waveform portion Wc is a waveform portion for allowing the open/close sections 12A and 12B to be in the closed state (the blocking state), and is a DC signal of 0 V in this example. In the open/close sections 12A and 12B supplied with the close drive waveform portion Wc, the potential difference between the transparent electrodes 15 and 17 which are arranged on both sides of the liquid crystal layer 19 (FIG. 5B) is 0 V, light transmittance T thereof is sufficiently low, and the open/close sections 12A and 12B become the closed state.

The open drive waveform portion Wo is a waveform portion for allowing the open/close sections 12A and 12B to be in the open state (the transmissive state), and is a pulse signal with a rectangular waveform which transits between −Vo and Vo (Vo is an open drive voltage) in this example. The open drive voltage Vo is a voltage necessary for the open/close sections 12A and 12B to be in the transmissive state, and is 8 V, for example. In the open/close sections 12A and 12B supplied with the open drive waveform portion Wo, the absolute value of the potential difference between the transparent electrodes 15 and 17 (FIG. 5B) is Vo. In the open/close sections 12A and 12B, the direction of the liquid crystal molecule is changed based on the absolute value Vo, light transmittance T is sufficiently high, and the open/close sections 12A and 12B become the open state.

The preparation drive waveform portion Wpre is a waveform portion for preparation as a step previous to the step of allowing the open/close sections 12A and 12B to be in the open state, and is a DC waveform having a pre-voltage Vpre in this example. In this case, the pre-voltage Vpre is a voltage lower than the open drive voltage Vo which is the absolute value of the voltage of the open drive waveform portion Wo, and is 5 V, for example. In the open/close sections 12A and 12B supplied with the preparation drive waveform portion Wpre, the absolute value of the potential difference between the transparent electrodes 15 and 17 arranged on the both sides of the liquid crystal layer 19 (FIG. 5B) is Vpre. At this time, light transmittance T of the open/close sections 12A and 12B is desirably sufficiently low as will be described later.

As illustrated in FIG. 7, the barrier drive section 41 repeatedly generates a unit signal U including the preparation drive waveform portion Wpre, the open drive waveform portion Wo, and the close drive waveform portion Wc, and the barrier drive section 41 supplies the unit signal U to the open/close sections 12A and 12B.

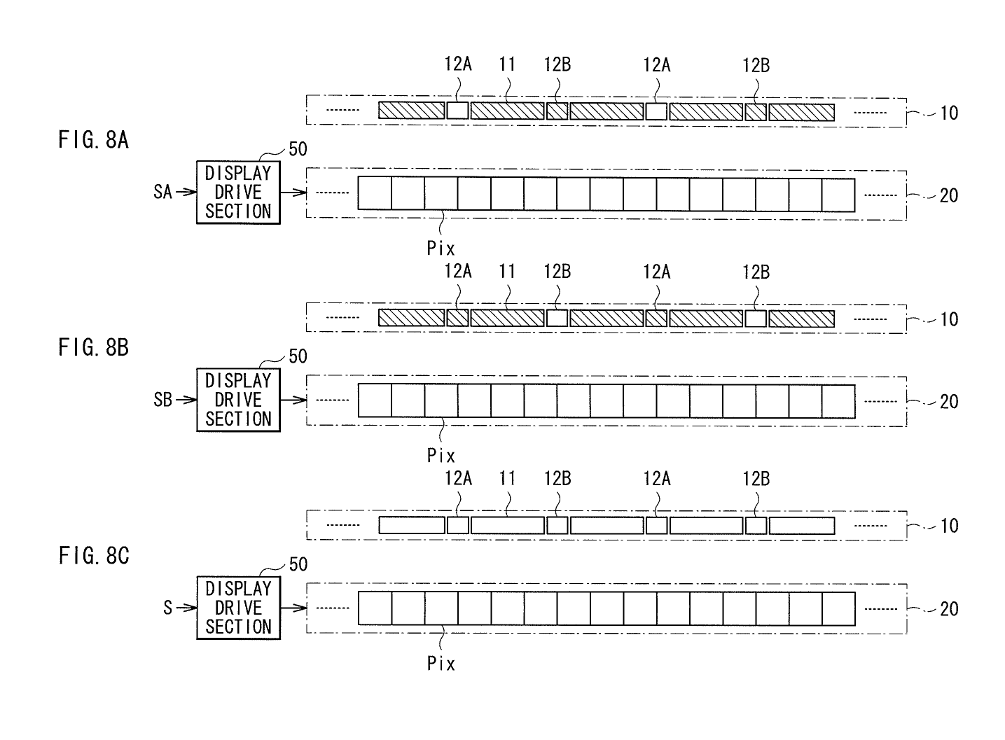

FIGS. 8A to 8C schematically illustrate, with use of a sectional configuration, the states of the liquid crystal barrier section 10 in the case where the stereoscopic display or the normal display (two-dimensional display) is performed, where FIG. 8A illustrates a state of performing the stereoscopic display, FIG. 8B illustrates another state of performing the stereoscopic display, and FIG. 8C illustrates a state of performing the normal display. The open/close sections 11 and the open/close sections 12 (12A and 12B) are alternately arranged in the liquid crystal barrier section 10. In this example, the open/close sections 12A are arranged so that one open/close section 12A corresponds to six pixels Pix in the display section 20. Likewise, the open/close sections 12B are arranged so that one open/close section 12B corresponds to six pixels Pix in the display section 20. In the following description, a pixel Pix is a pixel configured of three sub-pixels (RGB), but the pixel Pix is not limited thereto. For example, the pixel Pix may be a sub-pixel. In the liquid crystal barrier section 10, portions by which light is blocked are illustrated by hatched lines.

When the stereoscopic display is performed, the image signals SA and SB are alternately supplied to the display drive section 50, and the display section 20 performs display based on the signals. Then, in the liquid crystal barrier section 10, the open/close sections 12 (open/close sections 12A and 12B) perform open operation and close operation time-divisionally, and the open/close sections 11 maintain the closed state (the blocking state). Specifically, when the image signal SA is supplied, as illustrated in FIG. 8A, the open/close sections 12A become the open state, and the open/close sections 12B become the closed state. In the display section 20, as will be described later, adjacent six pixels Pix which are arranged at positions corresponding to the open/close section 12A perform display corresponding to six perspective images included in the image signal SA. As a result, as will be described later, the viewer views different perspective images with his left eye and right eye, for example, to perceive the displayed image as a stereoscopic image. Likewise, when the image signal SB is supplied, as described in FIG. 8B, the open/close sections 12B become the open state, and the open/close sections 12A become the closed state. In the display section 20, as will be described later, adjacent six pixels Pix which are arranged at positions corresponding to the open/close section 12B perform display corresponding to six perspective images included in the image signal SB. As a result, as will be described later, the viewer views different perspective images with his left eye and right eye, for example, to perceive the displayed image as a stereoscopic image. In this way, the stereoscopic display device 1 displays images by alternately opening the open/close sections 12A and the open/close sections 12B, thereby improving the resolution of the display device, as will be described later.

When the normal display (two-dimensional display) is performed, in the liquid crystal barrier section 10, as illustrated in FIG. 8C, the open/close sections 11 and the open/close sections 12 (12A and 12B) maintain the open state (the transmissive state). Therefore, the viewer is allowed to view a normal two-dimensional image as it is displayed on the display section 20 based on the image signal S.

In this case, the stereoscopic display device 1 corresponds to a specific example of “a display device” in the disclosure. The groups A and B correspond to a specific example of “barrier groups” in the disclosure. The open/close sections 12A and 12B correspond to a specific example of “liquid crystal barriers” in the disclosure. The open/close sections 11 correspond to a specific example of “liquid crystal sub-barriers” in the disclosure. The open drive voltage Vo corresponds to a specific example of “a first wave height value” in the disclosure. The open drive waveform portion Wo corresponds to a specific example of “a first waveform portion” in the disclosure. The pre-voltage Vpre corresponds to a specific example of “a second wave height value” in the disclosure. The preparation drive waveform portion Wpre corresponds to a specific example of “a second waveform portion” in the disclosure. The close drive waveform portion We corresponds to a specific example of “a third waveform portion” in the disclosure.

### [Operations and Functions]

Subsequently, operations and functions of the stereoscopic display device 1 according to the embodiment will be described.

### (General Operation Outline)

First, general operation outline of the stereoscopic display device 1 will be described referring to FIG. 1. The control section 40 supplies a control signal to each of the display drive section 50, the backlight drive section 42, and the barrier drive section 41, based on the image signal Sdisp supplied from the outside, and the control section 40 controls these sections to operate in synchronization with one another. The backlight drive section 42 drives the backlight 30 based on the backlight control signal CBL supplied from the control section 40. The backlight 30 emits surface-emitted light to the display section 20. The display drive section 50 drives the display section 20 based on the image signal S supplied from the control section 40. The display section 20 performs display by modulating light emitted from the backlight 30. The barrier drive section 41 generates the barrier drive signal DRV based on the barrier control signal CBR supplied from the control section 40 to supply the barrier drive signal DRV to the liquid crystal barrier section 10. The open/close sections 11 and 12 (12A and 12B) of the liquid crystal barrier section 10 perform open operation and close operation based on the barrier control signal CBR to allow light which has been emitted from the backlight 30 and then passed through the display section 20 to pass therethrough or to be blocked.

### (Detailed Operation of Stereoscopic Display)

Next, the detailed operation in the case where the stereoscopic display is performed will be described referring to some drawings.

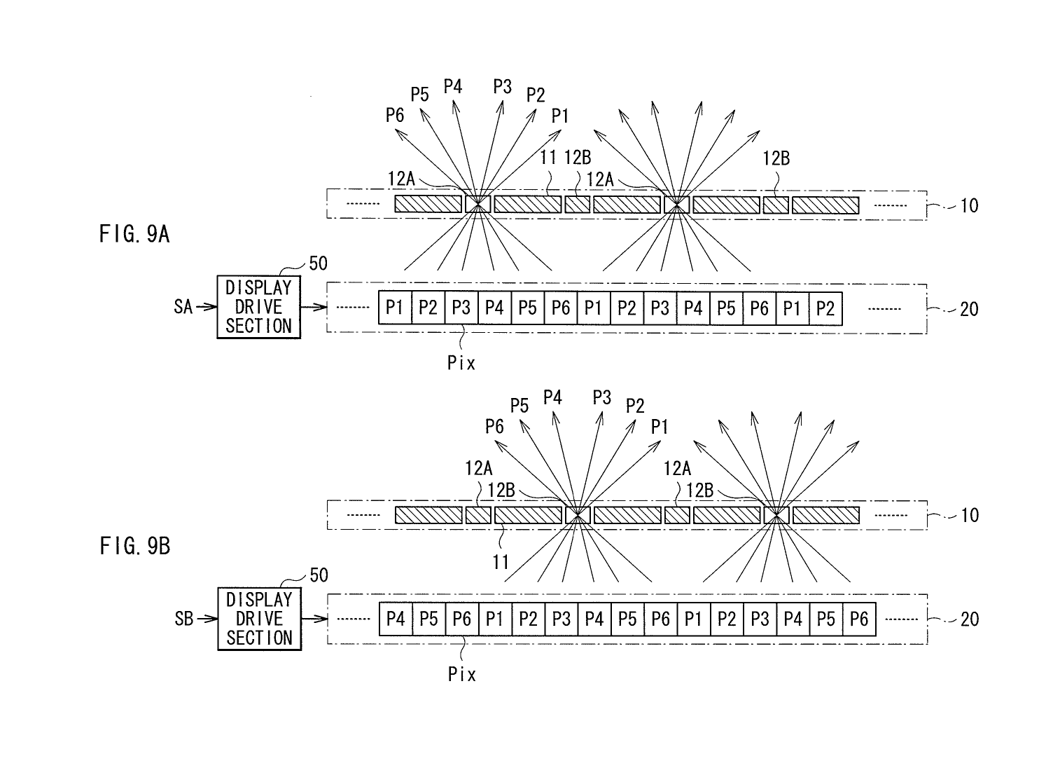

FIGS. 9A and 9B illustrate operation examples of the display section 20 and the liquid crystal barrier section 10, where FIG. 9A illustrates a case where the image signal SA is supplied and FIG. 9B illustrates a case where the image signal SB is supplied.

When the image signal SA is supplied, the pixels Pix of the display section 20 each display one piece out of pixel information P1 to P6 corresponding to six perspective images included in the image signal SA, respectively, as illustrated in FIG. 9A. At this time, the pieces of pixel information P1 to P6 are displayed on the pixels Pix arranged near the open/close sections 12A, respectively. When the image signal SA is supplied, in the liquid crystal barrier section 10, the open/close sections 12A and the open/close sections 12B are controlled to become the open state (the transmissive state) and the closed state, respectively. The light from each of the pixels Pix of the display section 20 is output with an angle limited by the open/close section 12A. The viewer is allowed to view a stereoscopic image through viewing the pixel information P3 with his left eye and the pixel information P4 with his right eye, for example.

When the image signal SB is supplied, the pixels Pix of the display section 20 each display one piece out of pixel information P1 to P6 corresponding to six perspective images included in the image signal SB, respectively, as illustrated in FIG. 9B. At this time, the pieces of pixel information P1 to P6 are displayed on the pixels Pix arranged near the open/close section 12B, respectively. When the image signal SB is supplied, in the liquid crystal barrier section 10, the open/close sections 12B and the open/close sections 12A are controlled to become the open state (the transmissive state) and the closed state, respectively. The light from each of the pixels Pix of the display section 20 is output with an angle limited by the open/close section 12B. The viewer is allowed to view a stereoscopic image through viewing the pixel information P3 with his left eye and the pixel information P4 with his right eye, for example.

In this way, the viewer views different pieces of pixel information between the pixel information P1 to P6 with his left eye and right eye, thereby being allowed to perceive the pixel information as a stereoscopic image. Moreover, the image is displayed by time-divisionally and alternately opening the open/close sections 12A and the open/close sections 12B, so that the viewer views images displayed on positions displaced from each other in an averaged manner. Accordingly, the stereoscopic display device 1 is allowed to achieve resolution twice as high as that in the case where only the open/close sections 12A are provided. In other words, the resolution of the stereoscopic display device is ⅓ (=⅙*2) of resolution in the case of two-dimensional display.

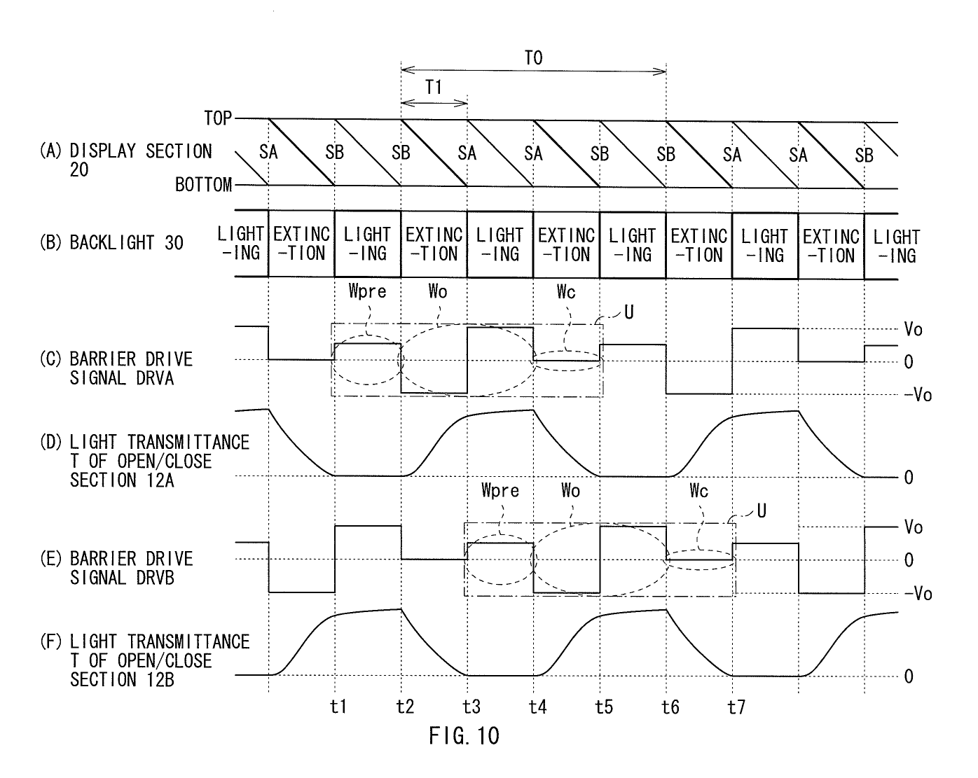

FIG. 10 illustrates a timing chart of the display operation in the stereoscopic display device 1, where (A) illustrates an operation of the display section 20, (B) illustrates an operation of the backlight 30, (C) illustrates a waveform of the barrier drive signal DRVA, (D) illustrates a light transmittance T of the open/close section 12A, (E) illustrates a waveform of the barrier drive signal DRVB, and (F) illustrates a light transmittance T of the open/close section 12B.

A vertical axis in (A) of FIG. 10 indicates a position of the display section 20 in the line-sequential scanning direction (y-axis direction). In other words, (A) of FIG. 10 illustrates an operation state of the display section 20 at a certain position in the y-axis direction at a certain time. In (A) of FIG. 10, “SA” indicates a state where the display section 20 performs display based on the image signal SA, and “SB” indicates a state where the display section 20 performs display based on the image signal SB.

The stereoscopic display device 1 time-divisionally performs display by the open/close sections 12A (display based on the image signal SA) and display by the open/close sections 12B (display based on the image signal SB) by line-sequential scanning performed in a scanning period T1. Then, these displays are repeated in each display period T0. Herein, the display period T0 may be, for example, 16.7 msec (corresponding to one period at 60 Hz). In this case, the scanning period T1 is 4.2 msec (a quarter of the display period T0).

The stereoscopic display device 1 performs display based on the image signal SA during the period from the timing t3 to the timing t4, and performs display based on the image signal SB during the period from the timing t5 to the timing t6.

First, during the period from the timing t1 to the timing t2, the barrier drive section 41 generates the preparation drive waveform portion Wpre of the barrier drive signal DRVA to supply the preparation drive waveform portion Wpre to the open/close sections 12A ((C) of FIG. 10). At this time, in the liquid crystal barrier section 10, the light transmittance T of the open/close sections 12A is maintained at sufficiently low level ((D) of FIG. 10).

Next, during the period from the timing t2 to the timing t3, the display section 20 is line-sequentially scanned from the top to the bottom thereof based on the drive signal supplied from the display drive section 50 so that the display based on the image signal SA is performed ((A) of FIG. 10). The barrier drive section 41 generates the open drive waveform portion Wo of the barrier drive signal DRVA to supply the open drive waveform portion Wo to the open/close sections 12A ((C) of FIG. 10). As a result, in the liquid crystal barrier section 10, the light transmittance T of the open/close sections 12A is increased ((D) of FIG. 10). Then, the backlight 30 does not emit light during the period from the timing t2 to the timing t3 ((B) of FIG. 10). Accordingly, the viewer does not view transitional change from the display based on the image signal SB to the display based on the image signal SA and transitional change of the light transmittance T of the open/close sections 12 so that the image quality deterioration is allowed to be reduced.

Then, during the period from the timing t3 to the timing t4, the display section 20 is line-sequentially scanned from the top to the bottom thereof based on the drive signal supplied from the display drive section 50 so that the display based on the image signal SA is performed again ((A) of FIG. 10). The barrier drive section 41 continuously generates the open drive waveform portion Wo of the barrier drive signal DRVA to supply the open drive waveform portion Wo to the open/close sections 12A ((C) of FIG. 10), and generates the preparation drive waveform portion Wpre of the barrier drive signal DRVB to supply the preparation drive waveform portion Wpre to the open/close sections 12B ((E) of FIG. 10). Accordingly, in the liquid crystal barrier section 10, the open/close sections 12A have the sufficiently high light transmittance T and become the open state ((D) of FIG. 10), and the open/close sections 12B have the sufficiently low light transmittance T and become the closed state ((F) of FIG. 10). Then, the backlight 30 emits light during the period from the timing t3 to the timing t4 ((B) of FIG. 10). Therefore, the viewer is allowed to view the display based on the image signal SA of the display section 20 during the period from the timing t3 to the timing t4. In addition, since the light transmittance T of the open/close sections 12B is sufficiently low, displays based on the image signals SA and SB are less likely to be mixed, and image quality deterioration due to so-called crosstalk is allowed to be reduced.

Next, during the period from the timing t4 to the timing t5, the display section 20 is line-sequentially scanned from the top to the bottom thereof based on the drive signal supplied from the display drive section 50 so that the display based on the image signal SB is performed ((A) of FIG. 10). The barrier drive section 41 generates the close drive waveform portion Wc of the barrier drive signal DRVA to supply the close drive waveform portion Wc to the open/close sections 12A ((C) of FIG. 10), and generates the open drive waveform portion Wo of the barrier drive signal DRVB to supply the open drive waveform portion Wo to the open/close sections 12B ((E) of FIG. 10). As a result, in the liquid crystal barrier section 10, the light transmittance T of the open/close sections 12A is decreased ((D) of FIG. 10), and the light transmittance T of the open/close sections 12B is increased ((F) of FIG. 10). The backlight 30 does not emit light during the period from the timing t4 to the timing t5 ((B) of FIG. 10). Accordingly, the viewer does not view transitional change from the display based on the image signal SA to the display based on the image signal SB and transitional change of the light transmittance T of the open/close sections 12 so that image quality deterioration is allowed to be reduced.

Then, during the period from the timing t5 to the timing t6, the display section 20 is line-sequentially scanned from the top to the bottom thereof based on the drive signal supplied from the display drive section 50 so that the display based on the image signal SB is performed again ((A) of FIG. 10). The barrier drive section 41 generates the preparation drive waveform portion Wpre of the barrier drive signal DRVA to supply the preparation drive waveform portion Wpre to the open/close sections 12A ((C) of FIG. 10), and continuously generates the open drive waveform portion Wo of the barrier drive signal DRVB to supply the open drive waveform portion Wo to the open/close sections 12B ((E) of FIG. 10). Accordingly, in the liquid crystal barrier section 10, the open/close sections 12A have the sufficiently low light transmittance T and become the closed state ((D) of FIG. 10), and the open/close sections 12B have the sufficiently high light transmittance T and become the open state ((F) of FIG. 10). Then, the backlight 30 emits light during the period from the timing t5 to the timing t6 ((B) of FIG. 10). Therefore, the viewer is allowed to view the display based on the image signal SB of the display section 20 during the period from the timing t5 to the timing t6. In addition, since the light transmittance T of the open/close sections 12A is sufficiently low, displays based on the image signals SA and SB are less likely to be mixed, and image quality deterioration due to so-called crosstalk is allowed to be reduced.

By repeating the above-described operations, the stereoscopic display device 1 alternately and repeatedly performs the display based on the image signal SA (the display by the open/close sections 12A) and the display based on the image signal SB (the display by the open/close sections 12B).

In this way, in the stereoscopic display device 1, the light transmittances T of the open/close sections 12A and 12B desirably transit to the open state in a short time after application of the open drive waveform portion Wo. Moreover, the light transmittances T of the open/close sections 12A and 12B are desirably sufficiently low in a period in which the preparation drive waveform portion Wpre is applied.

Subsequently, operations of the barrier drive section 41 and the liquid crystal barrier section 10 will be described.

FIG. 11 illustrates operation examples of the barrier drive section 41 and the liquid crystal barrier section 10 in the case where the open/close sections 12A and 12B of the liquid crystal barrier section 10 are changed from the closed state to the open state, where (A) illustrates a waveform example of the barrier drive signals DRVA and DRVB generated by the barrier drive section 41, and (B) illustrates the light transmittance T of the open/close sections 12A and 12B. In (B) of FIG. 11, the light transmittance T is defined with the proviso that final light transmittance when the barrier drive section 41 applies the open drive waveform portion Wo of the barrier drive signal DRV to the open/close sections 12A and 12B is 100%.

The barrier drive section 41 applies the preparation drive waveform portion Wpre and the open drive waveform portion Wo of the barrier drive signals DRVA and DRVB to the open/close sections 12A and 12B ((A) of FIG. 11) so that the light transmittances T of the open/close sections 12A and 12B are changed according to the pre-voltage Vpre of the preparation drive waveform portion Wpre, as illustrated in (B) of FIG. 11.

For example, in the case where the pre-voltage Vpre is 3 V, the light transmittance T is sufficiently low when the preparation drive waveform portion Wpre is applied, and is gradually increased after the application of the open drive waveform portion Wo to be close to 100%. The rise time Tr of the light transmittance T in this case is approximately 10.0 msec. Herein, the rise time Tr is a time period that the open/close sections 12A and 12B change from the closed state to the open state, and specifically, the rise time Tr is defined as a time period that the light transmittance T (relative value) changes from 5% to 90%. Moreover, for example, in the case where the pre-voltage Vpre is 8 V, the light transmittance T starts to increase when the preparation drive waveform portion Wpre is applied, and continuously increases after application of the open drive waveform portion Wo to be close to 100%. The rise time Tr in this case is approximately 12.4 msec.

On the other hand, in the case where the pre-voltage Vpre is 5 V, the light transmittance T is sufficiently low when the preparation drive waveform portion Wpre is applied and rapidly increases after application of the open drive waveform portion Wo to be close to 100%. The rise time Tr in this case is approximately 3.9 msec, and the light transmittance T increases faster than that under the above-described two conditions.

As illustrated in (B) of FIG. 11, in the open/close sections 12A and 12B, application of appropriate pre-voltage Vpre allows the rise time Tr of the light transmittance T to be shortened. This is because of the following reasons. In the closed state (the blocking state), a liquid crystal molecule in VA mode is aligned perpendicularly to the transparent substrates 13 and 16, and when the barrier drive signal DRV (the close drive waveform portion Wc) is applied to the transparent electrodes 17 so as to allow the open/close sections 12A and 12B to be in the open state (the transmissive state), the liquid crystal molecule is tilted towards a surface parallel to the transparent substrates 13 and 16 based on the potential difference between the transparent electrodes 15 and 17. At this time, to determine a direction to which the liquid crystal molecule is tilted, a method of aligning the liquid crystal molecule in the closed state in a predetermined direction slightly deviated from the perpendicular direction, that is, a method of adding so-called pretilt is often used. However, when the liquid crystal molecule aligned in the predetermined direction is tilted, in the case where the open drive waveform portion Wo is applied to the transparent electrodes 17 immediately after application of the close drive waveform portion Wc, the liquid crystal molecule is disturbed in the alignment direction transiently and is tilted, after that, the liquid crystal molecule takes a long time to return to the predetermined stable direction, thereby responding at a lower speed. In the embodiment, the barrier drive section 41 applies the preparation drive waveform portion Wpre (pre-voltage Vpre) to the transparent electrodes 17 before application of the open drive waveform portion Wo so that the disturbance in the alignment direction is suppressed and the liquid crystal molecule is allowed to be slightly tilted in a stable direction finally determined by the pretilt. Accordingly, since the tilt direction of the liquid crystal molecule is determined, the liquid crystal molecule is allowed to be tilted in the direction immediately when the open drive waveform portion Wo is applied to the transparent electrodes 17.

Incidentally, as for the above-described pretilt, when the angle (pretilt angle) of the liquid crystal molecule to be tilted with respect to the substrate surface is increased, the liquid crystal molecule is allowed to respond more quickly. However, in this case, the pretilt causes transmission of slight amount of light in despite of the closed state. In other words, a relationship of trade-off is present between contrast (ratio of the light transmittance in the open state and the closed state) and the response speed of the liquid crystal molecule. To allow the liquid crystal molecule to respond at high speed, it is necessary for the pretilt amount to be increased, however in this case, the contrast is lowered. On the other hand, to increase the contrast, it is necessary for the pretilt amount to be decreased, and thus the response speed of the liquid crystal molecule is decreased.

In the embodiment, for example, the pretilt amount is set to a minimal amount, and only when the open/close sections 12A and 12B are changed from the closed state to the open state, the barrier drive section 41 applies the pre-voltage Vpre to the open/close sections 12A and 12B to allow the liquid crystal molecules to be slightly tilted. In this way, when the pre-voltage Vpre is applied to the liquid crystal, the effect equivalent to that of the pretilt is obtainable and the response speed of the liquid crystal molecule thereafter is allowed to be increased. In addition, in the closed state, when the barrier drive section 41 applies the close drive waveform portion We to the open/close sections 12A and 12B, the potential difference between both ends of the liquid crystal is 0 V to reduce the light transmittance, and thus the contrast is allowed to be increased.

Moreover, as illustrated in (B) of FIG. 11, the light transmittance T of the open/close sections 12A and 12B is allowed to be sufficiently low by application of an appropriate pre-voltage Vpre during the period in which the preparation drive waveform portion Wpre is applied. In other words, when the liquid crystal molecule is slightly tilted by application of the pre-voltage Vpre, the pre-voltage Vpre not affecting the light transmittance T is preferably selected.

### [Effects]

As described above, in the embodiment, the barrier drive signal includes the preparation drive waveform portion with a pre-voltage so that the time change of the light transmittance of the open/close sections is adjustable.

In addition, in the embodiment, the pre-voltage is set to a predetermined value lower than the absolute value of the voltage of the open drive waveform portion so that a time necessary for the open/close sections to be changed from the closed state to the open state is allowed to be shortened during the period in which the open drive waveform portion is applied.

Moreover, in the embodiment, the pre-voltage is set to be lowered so that the light transmittance of the open/close sections is allowed to be sufficiently lowered during the period in which the preparation drive waveform portion is applied, and therefore the image quality deterioration due to crosstalk is allowed to be reduced.

### [Modification 1-1]

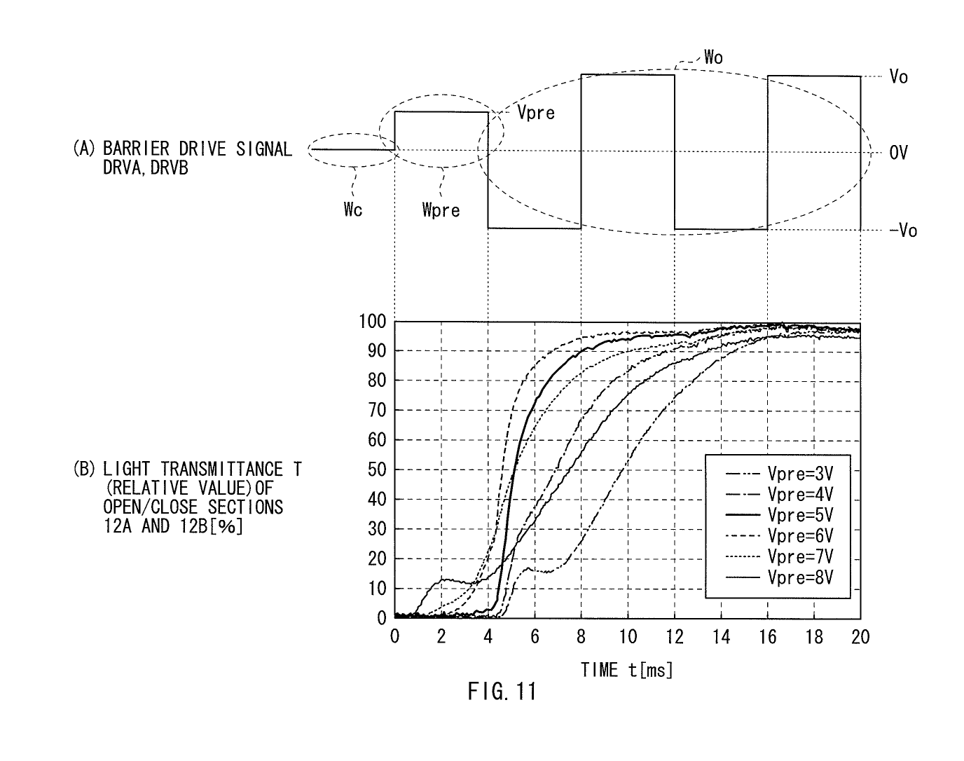

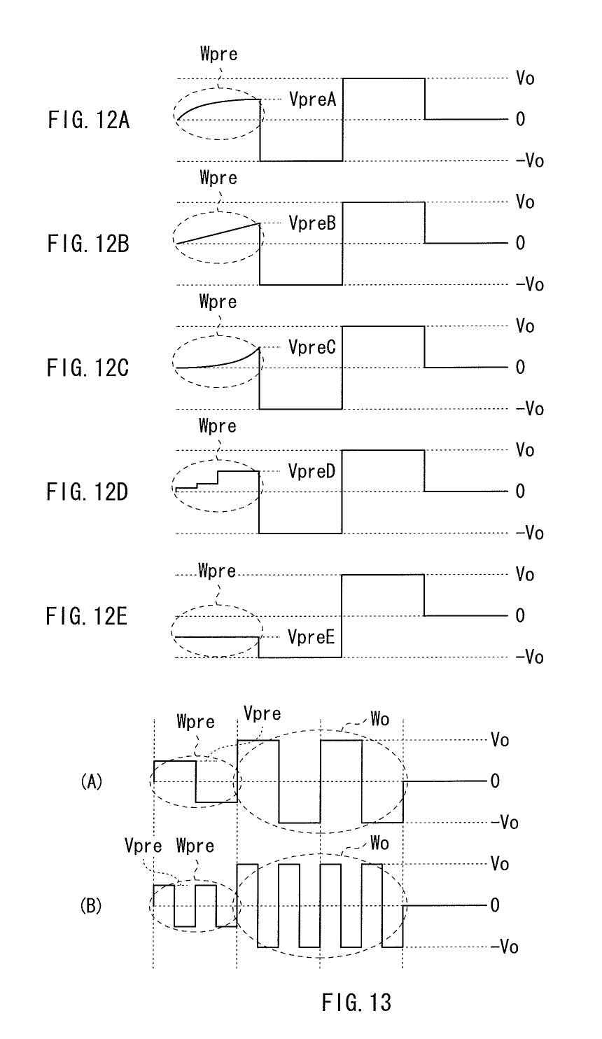

In the above-described embodiment, the preparation drive waveform portion Wpre is a DC waveform with a pre-voltage Vpre, but is not limited thereto. FIGS. 12A to 12E illustrate a unit signal U of the barrier drive signals DRVA and DRVB according to the modification. For example, the preparation drive waveform portion Wpre may be a waveform with a voltage increasing from 0 V to a pre-voltage VpreA like a sine curve as illustrated in FIG. 12A, may be a waveform with a voltage increasing from 0 V to a pre-voltage VpreB like a linear function as illustrated in FIG. 12B, or may be a waveform with a voltage increasing from 0 V to a pre-voltage VpreC like an exponent function as illustrated in FIG. 12C. Moreover, the preparation drive waveform portion Wpre may be a pulse waveform with a voltage increasing from 0 V to a pre-voltage VpreD in a plural stepwise manner as illustrated in FIG. 12D. In addition, the preparation drive waveform portion Wpre is not limited to waveforms with a voltage changing between 0 V and a pre-voltage Vpre like them, and for example, may be a DC waveform with a negative pre-voltage VpreE as illustrated in FIG. 12E. Note that in these cases, the pre-voltages VpreA to VpreE are not necessarily the same voltage. The pre-voltages VpreA to VpreE are determined after evaluation of the characteristics as illustrated in FIG. 11B is performed on the waveforms in FIGS. 12A to 12E, respectively.

### [Modification 1-2]

In the above-described embodiment, the barrier drive signals DRVA and DRVB have a voltage which transits during the scanning period T1, but the signals are not limited thereto. (A) and (B) of FIG. 13 illustrate a unit signal U of the barrier drive signals DRVA and DRVB according to the modification. For example, as illustrated in (A) of FIG. 13, the preparation drive waveform portion Wpre may be reversed every half period of the scanning period T1 and may have a frequency twice as high as that in the case of the above-described embodiment (for example, FIG. 7). In addition, as illustrated in (B) of FIG. 13, the preparation drive waveform portion Wpre may be reversed every quarter period of the scanning period T1 and may have a frequency four times as high as that in the case of the above-described embodiment. Incidentally, the direction of the liquid crystal molecule is controlled by the absolute values of the voltages of the barrier drive signals DRVA and DRVB, thereby not being affected from the reverse of the signal or the like. In the barrier drive signals DRVA and DRVB, a time period of a positive voltage and a time period of a negative voltage are equal, in length, to each other in the unit signal U so that influence of so-called burn-in of the liquid crystal in the liquid crystal barrier section 10 is allowed to be reduced.

### [Modification 1-3]

In the above-described embodiment, the time of the unit signal U of the barrier drive signals DRVA and DRVB is equal to the display period T0, but is not limited thereto. The modification will be described in detail below.

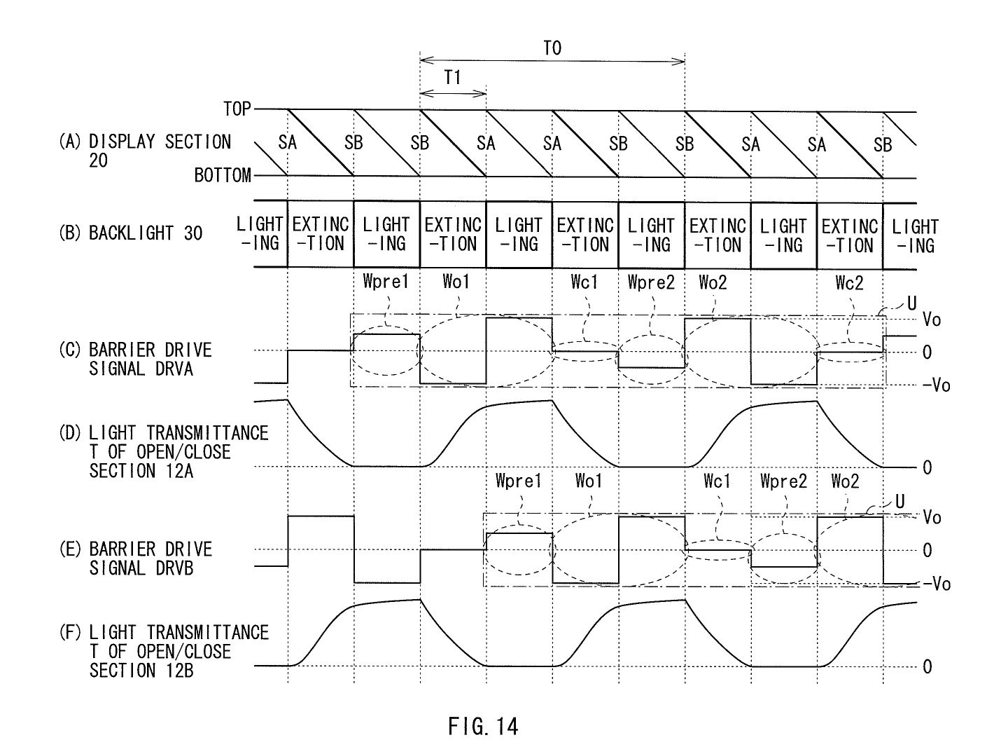

FIG. 14 illustrates a timing chart of a display operation of a stereoscopic display device according to the modification, where (A) illustrates an operation of the display section 20, (B) illustrates an operation of the backlight 30, (C) illustrates a waveform of the barrier drive signal DRVA, (D) illustrates a light transmittance T of the open/close section 12A, (E) illustrates a waveform of the barrier drive signal DRVB, and (F) illustrates a light transmittance T of the open/close section 12B. In the stereoscopic display device according to the modification, the barrier drive section generates the barrier drive signals DRVA and DRVB including a unit signal U with a length twice as long as the display period T0 to supply the barrier drive signals DRVA and DRVB to the open/close sections 12A and 12B, respectively.

The unit signal U includes six waveform portions, that is, a preparation drive waveform portion Wpre1, an open drive waveform portion Wo1, a close drive waveform portion Wc1, a preparation drive waveform portion Wpre2, an open drive waveform portion Wo2, and a close drive waveform portion Wc2. Herein, the preparation drive waveform portions Wpre1 and Wpre2 are waveforms reversed to each other, the open drive waveform portions Wo1 and Wo2 are waveforms reversed to each other, and the close drive waveform portions Wc1 and Wc2 are waveforms reversed to each other. In the barrier drive signals DRVA and DRVB, a time period of a positive voltage and a time period of a negative voltage are equal, in length, to each other in the unit signal U so that influence of so-called burn-in of the liquid crystal in the liquid crystal barrier section 10 is allowed to be reduced. Moreover, the barrier drive signals DRVA and DRVB according to the modification have the same frequencies as those in the case of the above-described embodiment (for example, FIG. 7) so that influence of the burn-in is allowed to be reduced without increasing the consumption current.

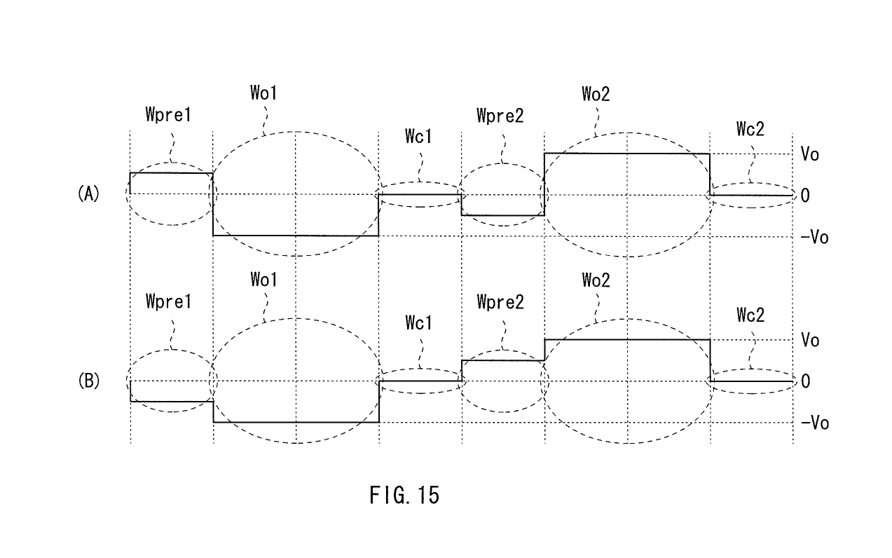

Furthermore, for example, as illustrated in (A) and (B) of FIG. 15, the voltage of each of the open drive waveform portions Wo1 and Wo2 may be set to be not changed. In other words, the open drive waveform portion Wo1 may be a waveform maintaining a voltage (−Vo) during a time period twice as long as the scanning period T1, and the open drive waveform portion Wo2 may be a waveform maintaining a voltage (Vo) during a time period twice as long as the scanning period T1. Also in this case, a time period of a positive voltage and a time period of a negative voltage are equal, in length, to each other in the unit signal U so that influence of so-called burn-in of the liquid crystal in the liquid crystal barrier section 10 is allowed to be reduced. In addition, since transition frequency of the barrier drive signals DRVA and DRVB is decreased, for example, consumption current is allowed to be reduced.

Moreover, in the modification, as illustrated in FIGS. 14 and 15, the unit signal U includes the six waveform portions, that is, the preparation drive waveform portion Wpre1, the open drive waveform portion Wo1, the close drive waveform portion Wc1, the preparation drive waveform portion Wpre2, the open drive waveform portion Wo2, and the close drive waveform portion Wc2, but the unit signal U is not limited thereto. For example, the unit signal U may be configured by repeating a waveform portion including the preparation drive waveform portion Wpre1, the open drive waveform portion Wo1, and the close drive waveform portion Wc1 plural times (for example, 10 times) and then repeating a waveform portion including the preparation drive waveform portion Wpre2, the open drive waveform portion Wo2, and the close drive waveform portion Wc2 plural times (for example, 10 times).

### 2. Second Embodiment

Next, a stereoscopic display device 2 according to a second embodiment of the disclosure will be described. In the embodiment, a temperature sensor is provided, and a pre-voltage Vpre is changed depending on a temperature. Incidentally, like numerals are used to designate substantially like components of the stereoscopic display device 1 according to the first embodiment, and the description thereof is appropriately omitted.

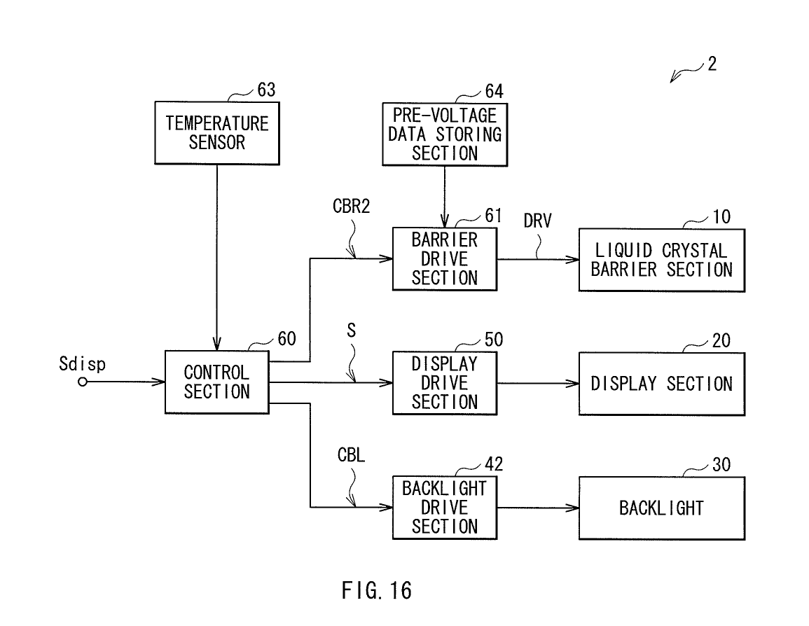

FIG. 16 illustrates a configuration example of the stereoscopic display device 2. The stereoscopic display device 2 includes a temperature sensor 63, a control section 60, a pre-voltage data storing section 64, and a barrier drive section 61. The temperature sensor 63 detects a temperature. The control section 60 controls the display drive section 50 and the backlight drive section 42, and controls the barrier drive section 61 based on temperature information supplied from the temperature sensor 63. The pre-voltage data storing section 64 includes a LUT (Look Up Table) 65 storing a plurality of pieces of pre-voltage data indicating a pre-voltage Vpre. The plurality of pieces of pre-voltage data indicates the pre-voltage Vpre in each of a plurality of temperature ranges set every 10° C., for example. The barrier drive section 61 has functions to select, based on temperature information supplied from the control section 60, pre-voltage data corresponding to the temperature from the LUT 65, to generate the barrier drive signals DRVA and DRVB including the pre-voltage Vpre based on the pre-voltage data, and to supply the barrier drive signals DRVA and DRVB to the open/close sections 12A and 12B in the liquid crystal barrier section 10, respectively.

Herein, the pre-voltage data storing section 64 corresponds to a specific example of “a wave height data storing section” in the disclosure.

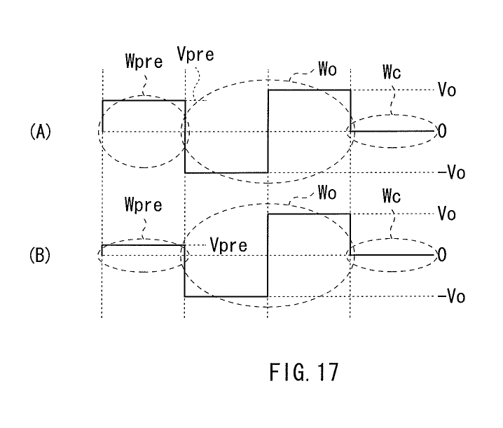

FIG. 17 illustrates waveforms of a unit signal U of the barrier drive signals DRVA and DRVB generated by the barrier drive section 61, where (A) illustrates a waveform in a case of low temperature, and (B) illustrates a waveform in a case of high temperature. As illustrated in FIG. 17, the pre-voltage Vpre of the preparation drive waveform portion Wpre is high in the case of low temperature ((A) of FIG. 17), and in contrast, is low in the case of high temperature ((B) of FIG. 17).

The viscosity of the liquid crystal is generally changed with temperature. In other words, the viscosity is high in the case of low temperature, and is low in the case of high temperature. Accordingly, the response characteristics of the liquid crystal molecules of the open/close sections 12A and 12B with respect to the potential difference between the transparent electrodes 15 and 17 are low in the case of low temperature, and in contrast, are high in the case of high temperature. Therefore, as illustrated in FIG. 17, in the stereoscopic display device 2, by setting the pre-voltage Vpre to be high in the case of low temperature and to be low in the case of high temperature, the change in the response characteristics caused by the temperature is reduced.

As described above, in the embodiment, since the pre-voltage is changed depending on the temperature, the change in the response characteristics when the temperature is changed is allowed to be reduced. The other effects are similar to those in the case of the above-described first embodiment.

Hereinbefore, although the technology has been described with referring to some embodiments and modifications, the technology is not limited to the embodiments and the like, and various modifications may be made.

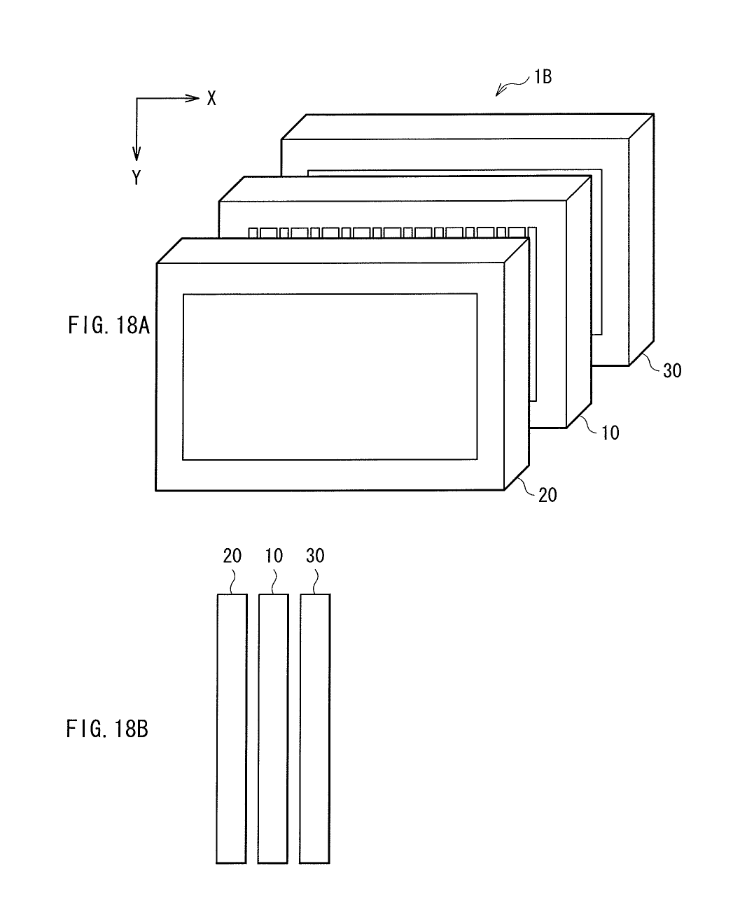

For example, in the above-described embodiments and the like, the backlight 30, the display section 20, and the liquid crystal barrier section 10 of the stereoscopic display device 1 are arranged in this order, but the arrangement is not limited thereto. Alternatively, as illustrated in FIGS. 18A and 18B, the arrangement in order of the backlight 30, the liquid crystal barrier section 10, and the display section 20 is available.

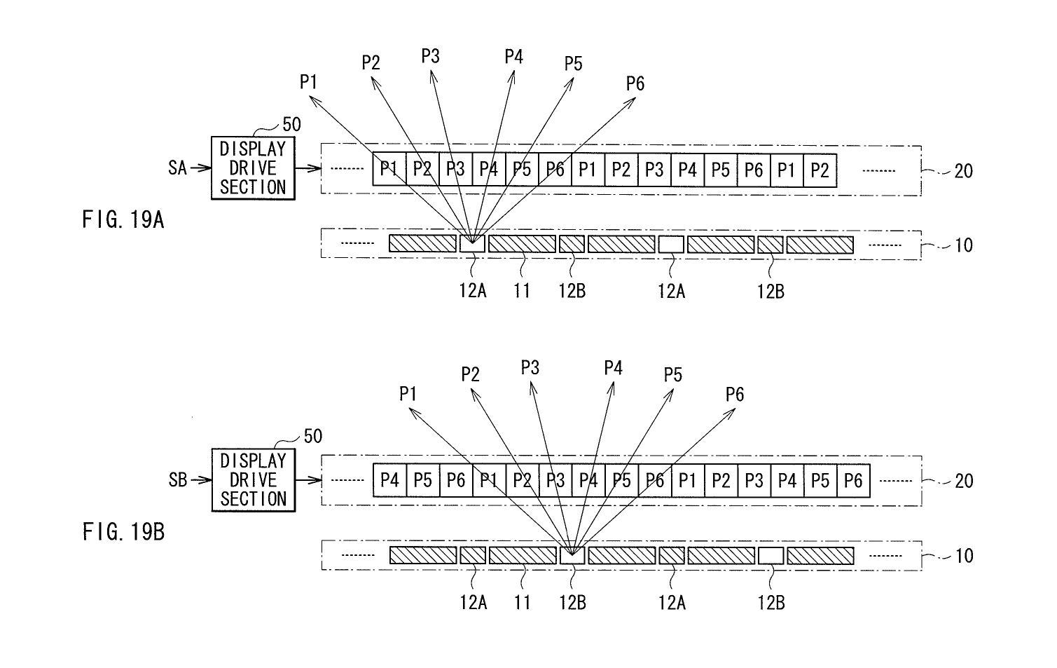

FIGS. 19A and 19B illustrate operation examples of the display section 20 and the liquid crystal barrier section 10 according to the modification, where FIG. 19A illustrates an operation example in the case where the image signal SA is supplied, and FIG. 19B illustrates an operation example in the case where image signal SB is supplied. In the modification, light emitted from the backlight 30 enters the liquid crystal barrier section 10 first. Then, the display section 20 modulates light having passed through the open/close sections 12A and 12B of the incident light, and outputs six perspective images.

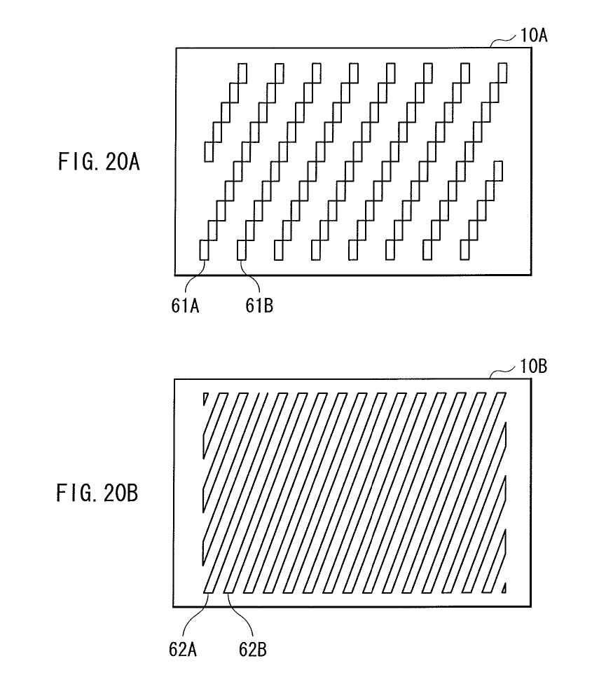

Moreover, for example, in the above-described embodiments and the like, the open/close sections of the liquid crystal barrier extend in the y-axis direction, but the direction is not limited thereto. Alternatively, for example, a step barrier type as illustrated in FIG. 20A or an oblique barrier type as illustrated in FIG. 20B is also available. The step barrier type is described in, for example, Japanese Unexamined Patent Application Publication No. 2004-264762. In addition, the oblique barrier type is described in, for example, Japanese Unexamined Patent Application Publication No. 2005-86506.

Furthermore, for example, in the above-described embodiments and the like, the open/close sections 12 configure two groups, but the number of groups is not limited thereto. Alternatively, the open/close sections 12 may configure, for example, three or more groups. As a result, the resolution of the display is further improved. The detail will be described below.

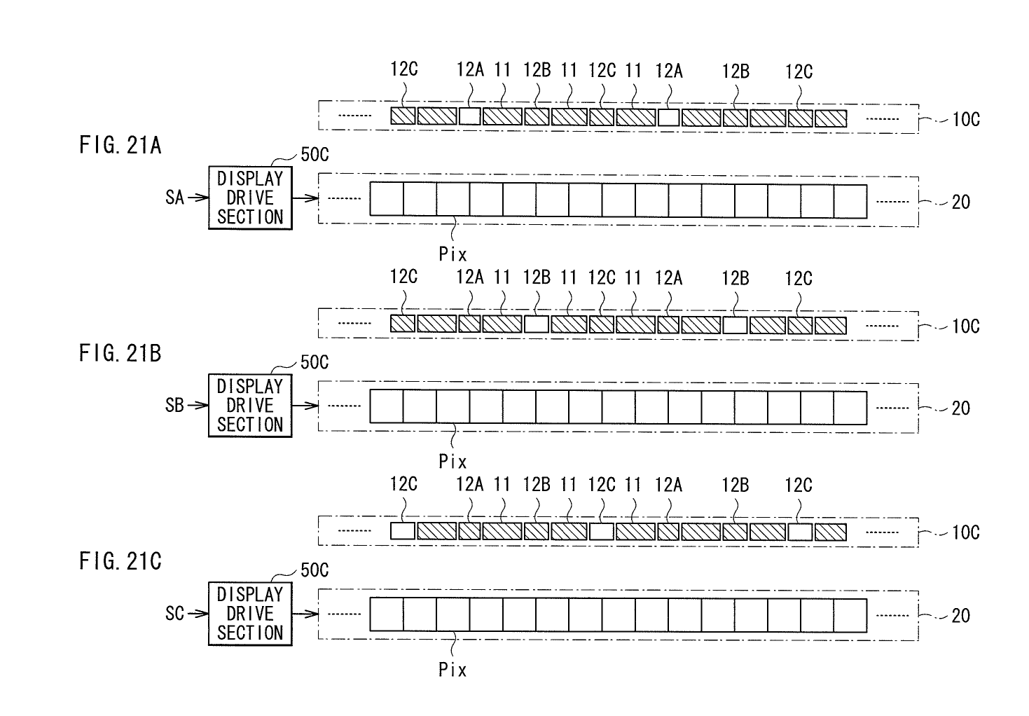

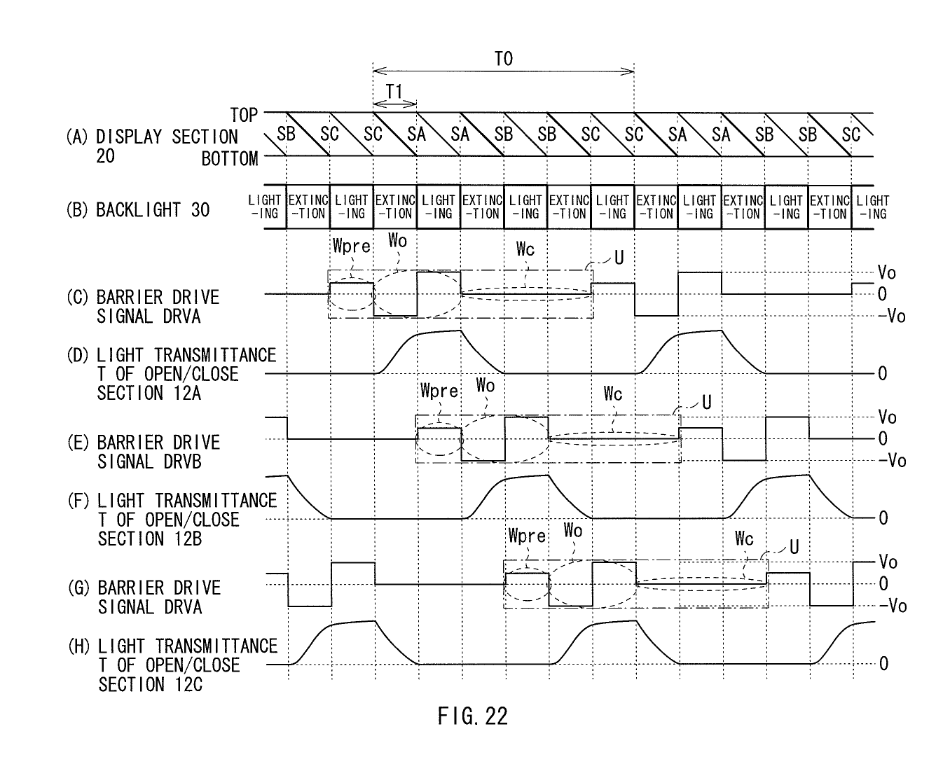

FIGS. 21A to 21C illustrate an example in the case where the open/close sections 12 configure three groups A, B, and C. As in the above-described embodiments, the open/close section 12A indicates the open/close section 12 included in the group A, the open/close section 12B indicates the open/close section 12 included in the group B, and an open/close section 12C indicates the open/close section 12 included in the group C.

FIG. 22 illustrates a timing chart of the display operation of the stereoscopic display device according to the modification, where (A) illustrates an operation of the display section 20, (B) illustrates an operation of the backlight 30, (C) illustrates a waveform of the barrier drive signal DRVA, (D) illustrates a light transmittance T of the open/close section 12A, (E) illustrates a waveform of the barrier drive signal DRVB, (F) illustrates a light transmittance T of the open/close section 12B, (G) illustrates a waveform of a barrier drive signal DRVC, and (H) illustrates a light transmittance T of the open/close section 12C. The barrier drive section according to the modification generates the barrier drive signals DRVA to DRVC to supply the barrier drive signals DRVA to DRVC to the open/close sections 12A to 12C, respectively. Accordingly, the open/close sections 12A, 12B, and 12C time-divisionally perform open operation and close operation cyclically.

In this way, the image is displayed by time-divisionally alternately opening the open/close sections 12A, 12B, and 12C so that the stereoscopic display device according to the modification is allowed to achieve resolution three times as high as in the case where only the open/close section 12A is provided. In other words, the resolution of the stereoscopic display device is ½ (=⅙*3) of resolution in the case of two-dimensional display.

Moreover, for example, in the above-described embodiments and the like, the image signals SA and SB each include six perspective images, but the number of perspective images is not limited thereto. The image signals SA and SB may include five or less perspective images or seven or more perspective images. In this case, the relationship between the open/close sections 12A and 12B of the liquid crystal barrier section 10 and the pixels Pix illustrated in FIGS. 8A to 8C is also changed. In other words, for example, in the case where the image signals SA and SB each include five perspective images, the open/close sections 12A are desirably arranged so that one open/close section 12A corresponds to five pixels Pix of the display section 20, and likewise, the open/close sections 12B are desirably arranged so that one open/close section 12B corresponds to five pixels Pix of the display section 20.

In addition, for example, in the above-described embodiments and the like, the display section 20 is a liquid crystal display section, but is not limited thereto. Alternatively, the display section 20 may be an EL display section using an organic EL (Electro Luminescence) and the like. In this case, the backlight drive section 42 and the backlight 30 illustrated in FIG. 1 are allowed to be eliminated.

The present application contains subject matter related to that disclosed in Japanese Priority Patent Application JP 2011-012179 filed in the Japan Patent Office on Jan. 24, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A display device comprising:
a liquid crystal barrier section including a plurality of liquid crystal barriers;
a barrier drive section configured to supply a plurality of barrier drive signals to the plurality of liquid crystal barriers to allow each of the liquid crystal barriers to be opened and closed; and
a display section configured to display images,
wherein each of the barrier drive signals includes a first waveform portion with a first wave height value, a second waveform portion, and a third waveform portion maintained at a basal potential, the second waveform portion being arranged immediately before the first waveform portion and having a second wave height value smaller than the first wave height value.

2. The display device according to claim 1, wherein:
the plurality of liquid crystal barriers is grouped into a plurality of barrier groups,
the barrier drive section is configured to supply the plurality of barrier drive signals, which are different from each other, to the plurality of barrier groups, to allow the plurality of liquid crystal barriers to perform an open operation and a close operation at timings which are different from one another between the barrier groups, and
the display section is configured to display images in synchronization with the open operation and the close operation of liquid crystal barriers included in each of the barrier groups.

3. The display device according to claim 2, wherein:
the barrier drive section is configured to set open operation periods to be arranged cyclically among the barrier groups, and, during each of the open operation periods, is configured to:
supply the first waveform portion to the liquid crystal barriers included in a barrier group which is intended to perform open operation,
supply the second waveform portion to the liquid crystal barriers included in a barrier group, which currently stays in a closed state and is intended to perform open operation, during a subsequent open operation period, and
supply the third waveform portion to the liquid crystal barriers included in a barrier group, which currently stays in the closed state and is intended to perform close operation during the subsequent open operation period.

4. The display device according to claim 3, further comprising:
a temperature sensor; and
a wave height data storing section configured to store a plurality of pieces of wave height data for instructing the second wave height value,
wherein the barrier drive section is configured to select one of the plurality of pieces of wave height data based at least in part on a detection result of the temperature sensor, and generate the barrier drive signals based at least in part on the selected wave height data.

5. The display device according to claim 3, wherein the barrier drive signal is a cyclic signal configured of a repeated arrangement of a first waveform unit which includes the second waveform portion, the first waveform portion, and the third waveform portion.

6. The display device according to claim 3, wherein the barrier drive signal includes first and second waveform units which are alternately arranged, the first waveform unit including the second waveform portion, the first waveform portion, and the third waveform portion, and the second waveform unit being an inversion of the first waveform unit.

7. The display device according to claim 3, wherein the barrier drive signal includes a time period of a positive voltage and a time period of a negative voltage, which are equal in length to each other.

8. The display device according to claim 3, wherein the second waveform portion has a DC waveform.

9. The display device according to claim 3, wherein the second waveform portion has a waveform with alternately-inverted polarity.

10. The display device according to claim 3, wherein the second wave height value is a voltage level, which allows the liquid crystal barriers to stay in a closed state through applying the second waveform portion thereto.

11. The display device according to claim 3, wherein the plurality of liquid crystal barriers each extend in a predetermined direction, and are arranged side by side to allow the barrier groups to be cyclically repeated in a direction intersecting the predetermined direction.

12. The display device according to claim 3, having a plurality of display modes including a three-dimensional image display mode and a two-dimensional image display mode, and the liquid crystal barrier section further including a plurality of liquid crystal sub-harriers,
wherein the three-dimensional image display mode allows at least one three-dimensional image to be displayed, through displaying a plurality of different perspective images by the display section, allowing the plurality of liquid crystal barriers to stay in an opened state, and allowing the plurality of liquid crystal sub-barriers to stay in the closed state, and
the two-dimensional image display mode allows at least one two-dimensional image to be displayed, through displaying one perspective image, and allowing both the plurality of liquid crystal barriers and the plurality of liquid crystal sub-barriers to stay in the opened state.

13. The display device according to claim 3, further comprising a backlight, wherein the display section is configured of a liquid crystal display section disposed between the backlight and the liquid crystal barrier section.

14. The display device according to claim 3, further comprising a backlight, wherein the display section is configured of a liquid crystal display section, and
the liquid crystal barrier section is disposed between the backlight and the liquid crystal display section.

15. A barrier device comprising:
a liquid crystal barrier section including a plurality of liquid crystal barriers; and
a barrier drive section configured to supply a plurality of barrier drive signals to the plurality of liquid crystal barriers to allow each of the liquid crystal barriers to be opened and closed,
wherein each of the barrier drive signals includes a first waveform portion with a first wave height value, a second waveform portion, and a third waveform portion maintained at a basal potential, the second waveform portion being arranged immediately before the first waveform portion and having a second wave height value smaller than the first wave height value.

16. A method of driving a display device, the method comprising:
supplying a plurality of barrier drive signals which are different from one another to a plurality of liquid crystal barriers, to allow each of the liquid crystal barriers to be opened and closed, the plurality of barrier drive signals each including a first waveform portion with a first wave height value, a second waveform portion, and a third waveform portion maintained at a basal potential, the second waveform portion being arranged immediately before the first waveform portion and having a second wave height value smaller than the first wave height value; and
displaying images on a display section.

17. The method of driving a display device according to claim 16, wherein:
the plurality of liquid crystal barriers is grouped into a plurality of barrier groups, the plurality of barrier drive signals, which are different from each other, is supplied to the plurality of barrier groups to allow the plurality of liquid crystal barriers to perform an open operation and a close operation at timings which are different from one another between barrier groups, and
the display section is configured to display images in synchronization with the open operation and the close operation of the liquid crystal barriers included in each of the barrier groups.

18. The display device comprising:
a liquid crystal barrier section including a liquid crystal layer, a first transparent substrate, a second transparent substrate, a plurality of first transparent electrodes arranged on a liquid crystal layer side of the first transparent substrate, and a second transparent electrode arranged on a liquid crystal layer side of the second transparent substrate;
a drive section configured to supply a drive signal to the plurality of first transparent electrodes; and
a display section, wherein:
the drive signal includes a basal potential, a first potential, and a second potential close to the basal potential compared with the first potential,
the second transparent electrodes are supplied with the basal potential, and
the first transparent electrodes are supplied with the second potential after the basal potential is supplied and before the first potential is supplied.
